(19) United States
(12) Patent Application Publication
(10) Pub. No.: US 2013/0022843 A1
(43) Pub. Date: Jan. 24, 2013

(54) ASSEMBLED BATTERY AND METHOD OF CONTROLLING ASSEMBLED BATTERY

(71) Applicant: Masayuki Tohda, Fukushima (JP)

(72) Inventor: Masayuki Tohda, Fukushima (JP)

(73) Assignee: SONY CORPORATION, Tokyo (JP)

(21) Appl. No.: 13/522,269

(22) PCT Filed: Jan. 14, 2011
(86) PCT No.: PCT/JP2011/051036

§ 371 Date: Oct. 9, 2012

(30) Foreign Application Priority Data
Jan. 21, 2010 (JP) 2010-010948

(51) Int. Cl. H01M 2/20

(52) U.S. Cl. 429/50; 429/158

(57) ABSTRACT

There is provided an assembled battery allowed to compute and detect an SOC easily with high accuracy while increasing energy density. An assembled battery 1 is configured by connecting batteries BT₁ to BTₙ₋₁ and a battery BTₙ in series. A discharge curve of each of the batteries BT₁ to BTₙ₋₁ exhibits substantially flat characteristics, and a discharge curve of the battery BTₙ exhibits slope characteristics. The SOC or DOD of the assembled battery 1 is detected from the battery voltage of the battery BTₙ by a battery control unit 3. As the discharge curve of the battery BTₙ exhibits slope characteristics, the battery voltage is allowed to be detected easily with high accuracy. As the batteries BT₁ to BTₙ₋₁ have high energy density, the energy density of the whole assembled battery 1 is allowed to be increased, and the size and weight of the assembled battery 1 are allowed to be reduced.

### TECHNICAL FIELD

The present invention relates to an assembled battery applied to a nonaqueous electrolyte secondary battery, for example, a vehicle-mounted lithium-ion secondary battery, and a method of controlling the assembled battery.

### BACKGROUND ART

Recently, assembled batteries using a plurality of lightweight high-capacity single secondary batteries are used as power supplies for electronic devices. To replace oil with an alternative fuel and reduce carbon dioxide, batteries are used as driving power supplies for not only electronic devices but also industrial equipment such as electric bicycles, electric motorcycles and forklifts. Moreover, an assembled battery using a plurality of lightweight high-capacity single secondary batteries is used as a driving power supply for vehicle such as EV (Electric Vehicle), HEV (Hybrid Electric Vehicle) and PHEV (Plug-in Hybrid Electric vehicle). The PHEV is a vehicle including a secondary battery for hybrid vehicle which is rechargeable from a household outlet so as to travel for a certain distance as an electric vehicle. In particular, a small, lightweight lithium-ion secondary battery with high energy density (hereinafter simply referred to as lithium-ion battery) is suitable as a vehicle-mounted battery.

As a material used for an anode of the lithium-ion secondary battery, for example, graphite-based materials and hard carbon-based materials are known. A lithium-ion secondary battery including a graphite-based anode has a relatively flat discharge curve. A lithium-ion secondary battery including a hard carbon-based anode has a downward-sloping discharge curve.

In related art, for example, PTL 1, an assembled battery configured by connecting, in series, an aqueous secondary battery and a nonaqueous secondary battery having smaller battery capacity than that of the aqueous secondary battery is described. The assembled battery with this configuration includes a combination of different types of batteries in order to prevent the aqueous secondary battery from being overcharged and to increase a charging depth at the end of charge.

### CITATION LIST

### Patent Literature

PTL 1: Japanese Unexamined Patent Application Publication No. 2009-004349

### SUMMARY OF INVENTION

In the case where a battery is used as a vehicle-mounted battery, to fully deliver performance and secure safety, management is necessary. For example, during charge, charge management is necessary to secure the charge capacity of the battery and prevent an accident. As discharge management for fully delivering performance, it is necessary to detect the SOC (State Of Charge) or the DOD (Depth Of Discharge) of the battery, and to secure safety, it is necessary to monitor the voltage, the current and the temperature of the battery. For example, to make full use of the performance of the battery, the remaining capacity of the battery is estimated.

One method of estimating the remaining capacity is a method of accumulating input/output currents with signs of the battery for a certain period and calculating battery capacity (Ah) in percentage terms. However, an error in measurement of input/output currents occurs due to a rapid load change, a measurement accuracy error or self-discharge. On the other hand, in the lithium-ion battery, the SOC or the DOD is highly dependent on OCV (Open Circuit Voltage); therefore, correction, and estimation of the remaining capacity are allowed to be performed with use of OCV vs. capacity characteristics in a no-load state (or in a state where a load is extremely low). The OCV vs. capacity characteristics correspond to a discharge curve.

In the case where the SOC, for example, the remaining capacity is detected from the discharge curve, the remaining capacity is detected more easily with higher detection accuracy from a downward-sloping discharge curve than from a flat discharge curve. However, a lithium-ion secondary battery including a hard carbon-based anode so as to have a downward-sloping discharge curve has an issue of reduction in capacity. Moreover, the lithium-ion secondary battery including the hard carbon-based anode has smaller weight energy density, smaller volume energy density and higher cost than those of a lithium-ion battery including a graphite-based anode. Therefore, in the case where an assembled battery is configured of only lithium-ion batteries including hard carbon-based anodes, the assembled battery has issues of increases in size, weight and cost thereof.

Therefore, it is an object of the invention to provide an assembled battery having high weight energy density and high volume energy density while preventing upsizing thereof, and a method of controlling the assembled battery.

To solve the above-described issue, the present invention provides an assembled battery including: one or a plurality of first single batteries and one or a plurality of second single batteries which are connected in series to one another, the first single batteries having a discharge curve which exhibits substantially flat characteristics, the second single batteries having a discharge curve which exhibits slope characteristics.

The present invention provides a method of controlling an assembled battery, the assembled battery including one or a plurality of first single batteries and one or a plurality of second single batteries which are connected in series to one another, the first single batteries having a discharge curve which exhibits substantially flat characteristics, the second single batteries having a discharge curve which exhibits slope characteristics, the method including a step of: detecting an SOC or a DOD of the assembled battery from a terminal voltage of the second single battery.

Preferred modes are as follows.

The one or the plurality of first single batteries use a graphite-based anode material and the one or the plurality of second single batteries use a hard carbon-based anode material.

The one or the plurality of first single batteries and the one or the plurality of second single batteries are configured so as to have substantially equal discharge capacity.

According to the invention, when the first single batteries having the discharge curve which exhibits substantially flat characteristics are used, a decline in capacity is preventable, and an assembled battery with high weight energy density and high volume energy density is achievable. Therefore, the weight and size of the assembled battery are allowed to be reduced. On the other hand, the invention has an advantage that when the second single batteries having the discharge curve which exhibits slope characteristics are used, the SOC is easily detected.

### BRIEF DESCRIPTION OF DRAWINGS

FIG. 1 is a block diagram of a first embodiment of the invention.

FIG. 2 is a graph illustrating a discharge curve of a battery used in the first embodiment of the invention.

FIG. 3 is a graph illustrating a discharge curve for describing one example of a cathode material applicable to a second battery of the invention.

FIG. 4 is a graph illustrating a discharge curve for describing another example of the cathode material.

FIG. 5 is a graph illustrating a discharge curve for describing one example of a cathode material applicable to a first battery of the invention.

FIG. 6 is a graph illustrating a discharge curve for describing one example of an anode material applicable to the second battery of the invention.

FIG. 7 is a graph illustrating a discharge curve for describing another example of the anode material applicable to the second battery of the invention.

### DESCRIPTION OF EMBODIMENTS

An embodiment of the present invention will be described below. Description will be given in the following order.

### 1. First Embodiment

### 2. Modification Examples

Although the embodiment of the present invention will be described below with various technically preferred limitations, the scope of the present invention is not limited thereto unless otherwise described below.

### 1. First Embodiment

### Assembled Battery and Control Section

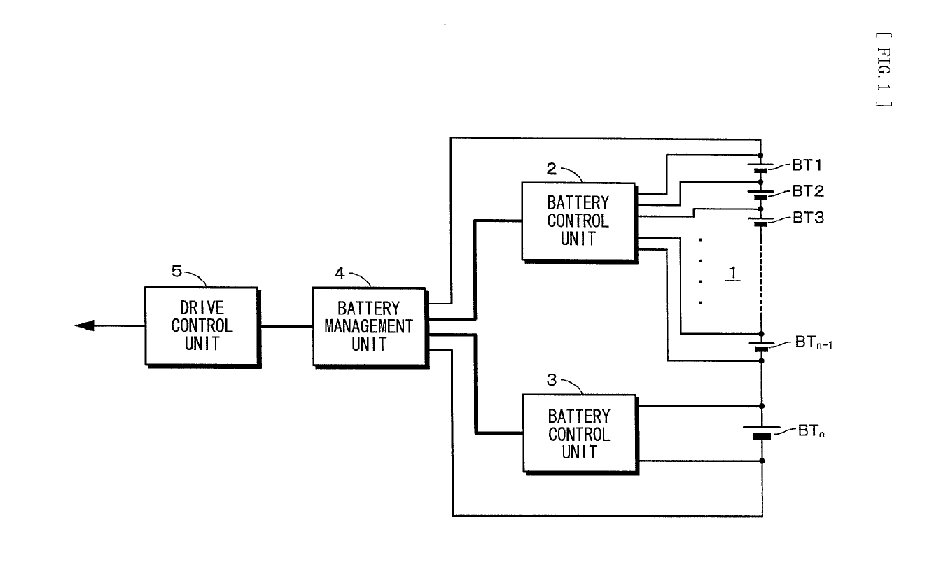

FIG. 1 illustrates an assembled battery according to a first embodiment of the invention. The assembled battery herein means a battery with a configuration in which a plurality of single batteries, for example, lithium-ion batteries are connected in series to one another. A battery pack is configured by connecting a plurality of batteries to a battery control unit for the batteries, and further connecting a battery management unit to the battery control unit.

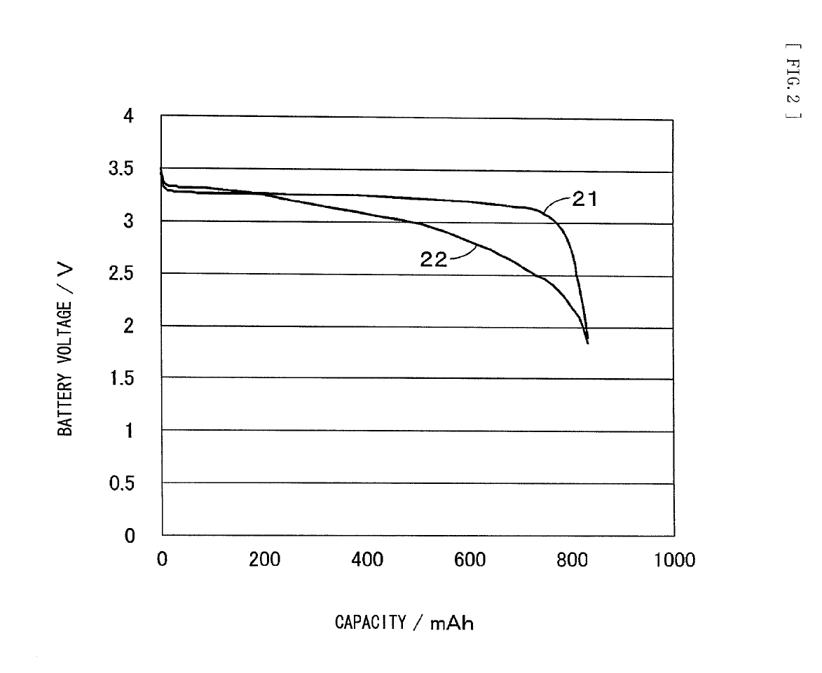

An assembled battery 1 is configured by connecting, in series, a number n of batteries BT₁ to BTₙ to one another. Each of the batteries BT₁ to BTₙ₋₁ is a first single battery having a discharge curve which exhibits substantially flat characteristics. One battery BTₙ is a second single battery having a discharge curve which exhibits slope characteristics. For example, in FIG. 2, a reference numeral 21 indicates a discharge curve of a single battery (hereinafter referred to as battery, if necessary) using lithium iron phosphate (LiFePO₄) for a cathode and graphite for an anode. The discharge curve 21 is substantially flat. The batteries BT₁ to BTₙ₋₁ each have the discharge curve 21.

A reference numeral 22 indicates a discharge curve of a battery using the same material as that of the above-described battery for a cathode and hard carbon for an anode. The discharge curve 22 of the battery BTₙ exhibits such slope characteristics. The discharge curves 21 and 22 indicate changes in capacity vs. voltage when the battery is charged in CC (constant current)-CV (constant voltage) mode, and then discharged at a predetermined constant current until reaching a predetermined voltage. The discharge curves 21 and 22 are measured at room temperature, for example, 23° C.

In the first embodiment of the invention, the slope characteristics exhibited by the second single battery are defined as follows.

In a region where the SOC of the second single battery is within a range of 20% to 80%,

ΔV/ΔSOC %>50 mV/10%

where ΔV is a battery voltage change amount, and ΔSOC is an SOC change amount.

The capacity of each of the batteries BT₁ to BTₙ₋₁ and the capacity of the battery BTₙ are set to be equal to each other. When the batteries BT₁ to BTₙ₋₁ and the battery BTₙ have equal sizes, the capacity of the battery BTₙ is 70% to 80% of the capacity of each of the batteries BT₁ to BTₙ₋₁. In other words, when two kinds of batteries have equal capacity, the size of the battery BTₙ is larger by approximately 30% than the size of each of the batteries BT₁ to BTₙ₋₁. Therefore, in the case where the assembled battery 1 is assembled, it is preferable to assemble the battery BTₙ following a serial connection of the batteries BT₁ to BTₙ₋₁. Alternatively, the battery BTₙ may be assembled first, and then the batteries BT₁ to BTₙ₋₁ may be assembled following the battery BTₙ.

Moreover, the cost of the battery BTₙ is higher than that of each of the batteries BT₁ to BTₙ₋₁. Therefore, to reduce the size and weight of the battery pack, the number of the second batteries is smaller than the number of the first batteries in the number n of batteries configuring the assembled battery. In the first embodiment, a number n−1 of the first batteries BT₁ to BTₙ₋₁ and one second battery BTₙ are used. However, these numbers are just one example, and the numbers are arbitrarily selected. In addition, as electrode materials of the first battery and the second battery, as will be described later, other kinds of materials may be used.

A battery control unit 2 is provided for the serial connection of the first batteries BT₁ to BTₙ₋₁, and a battery control unit 3 is provided for the second battery BTₙ. A voltage between both ends of each of the batteries BT₁ to BTₙ₋₁ is supplied to the battery control unit 2. A voltage between both ends of the battery BTₙ is supplied to the battery control unit 3. Output information of these battery control units 2 and 3 and a voltage between both ends of the whole assembled battery 1 are supplied to a battery management unit 4. The output information is transmitted through a bus for digital signal transmission.

An output signal of the battery management unit 4 is supplied to a drive control unit 5. The assembled battery 1 according to the first embodiment of the invention is applicable as a drive source for EV (Electric Vehicle) or HEV (Hybrid Electric Vehicle). An inverter (not illustrated) and a motor (not illustrated) are connected to the drive control unit 5, and an engine rotates by the motor. Moreover, a display section is connected to the drive control unit 5 to display, for example, a distance-to-empty. In FIG. 1, one assembled battery is illustrated, but in the case where the assembled battery is used as a drive source of EV or HEV, a large number of assembled batteries are connected in series to one another.

The battery control unit 2 includes a voltage detection section detecting the voltage of each of the batteries BT₁ to BTₙ₋₁, a temperature detection/control section detecting and controlling the temperature of each battery, and a balance adjustment section adjusting a balance between voltages. The battery control unit 3 includes a voltage detection section detecting the voltage of the battery BTₙ, a temperature detection/control section detecting the temperature of the battery BTₙ, and an SOC computation section. In the case where a plurality of second batteries are used, the battery control unit 3 also includes a balance adjustment section.

The temperature detection/control section forms a control signal for temperature control from a temperature detection result of each battery to supply the temperature control signal to the battery management unit 4, and the battery management unit 4 controls ON/OFF of a cooling fan so as to control the battery temperature to, for example, 50° C. or less. Moreover, in the case where the temperature abnormally rises due to an overload, the battery management unit 4 limits charge/discharge of the battery. Further, in the case where the battery temperature is at a predetermined temperature or less, for example, 10° C. or less, the battery is charged at a charge current predetermined by the battery temperature so as to prevent lithium deposition or the like, thereby preventing deterioration of the battery.

The voltage detection section detects the voltage of each battery. The balance adjustment section determines whether variations in the detected voltage are within a predetermined tolerable range, for example, 50 mV or less, and turns on an FET (Field Effect Transistor) connected in parallel to a battery exceeding the tolerable range so that a very small current is discharged from the battery. Such a discharge operation is performed during suspension of charge and discharge. The discharge operation allows variations in the voltage of the battery to fall within the tolerable range. Balance adjustment allows the amount of available power of the battery pack to increase, thereby increasing the life of the battery pack.

The SOC computation section detects the SOC of the battery BTₙ during suspension of charge and discharge by comparing an OCV in a discharge curve stored in advance to the voltage of the battery BTₙ. In this case, temperature correction is performed. The SOC of the battery BTₙ corresponds to the SOC of the assembled battery 1. Moreover, internal resistance of the battery is detected from a voltage change due to a voltage rise or a voltage drop during charge and discharge and a current flowing through the battery, and the OCV in the discharge curve is allowed to be corrected according to the degree of a change in the internal resistance by a deterioration factor stored in advance, and the SOC according to the deterioration of the battery is allowed to be computed. Chargeable-dischargeable power is allowed to be determined by the detected SOC, temperature and deterioration state.

The battery management unit 4 produces control information for controlling charge and discharge of the assembled battery 1 by receiving information from the battery control units 2 and 3. An electronic device such as a display section or a drive system such as a motor is connected to the drive control unit 5 to which information from the battery management unit 4 is supplied.

In the above-described first embodiment of the invention, the SOC is detected or computed from the voltage of the battery BTₙ having the discharge curve which exhibits slope characteristics, so the SOC (or the DOD) of the assembled battery 1 is detectable easily and accurately. Moreover, as the battery BTₙ is combined with the batteries BT₁ to BTₙ₋₁ having a relatively flat discharge curve, the assembled battery 1 having high energy density and easily controlling charge and discharge is achievable.

The assembled battery configured in such a manner is applicable to an electronic device such as a notebook computer, a cellular phone, a cordless handset, a videotape camera-recorder, a liquid crystal display television, an electric shaver, a portable ratio, a headphone stereo, a back-up power supply or a memory card, a medical instrument such as a pacemaker or a hearing aid, a power tool, a power supply for driving an electric vehicle (including a hybrid vehicle) (including the case where the power supply is combined and used with another power source), or a power supply for power storage.

### Electrode Materials of Assembled Battery

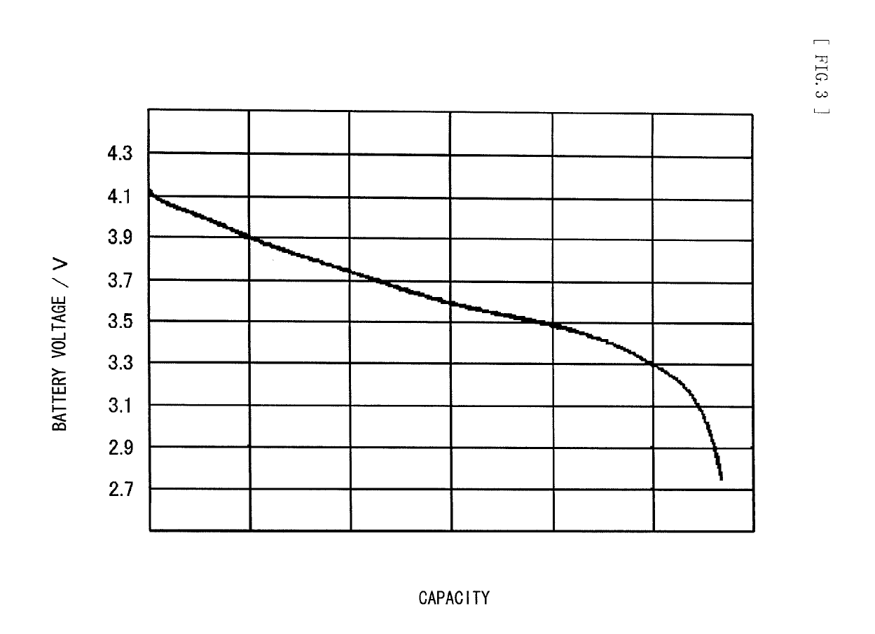

In the above description, the discharge curve 21 of each of the batteries BT₁ to BTₙ₋₁ including the cathode made of LiFePO₄ and the anode made of graphite and the discharge curve 22 of the battery BTₙ including the cathode made of LiFePO₄ and the anode made of hard carbon are described. As a battery having a discharge curve which exhibits the same slope characteristics as those of the discharge curve 22, as illustrated in FIG. 3, a battery including a cathode made of Ni-based material (NCA) and an anode made of graphite is used. NCA is a solid solution of Ni, Co and Al. Such a battery is used as the second battery.

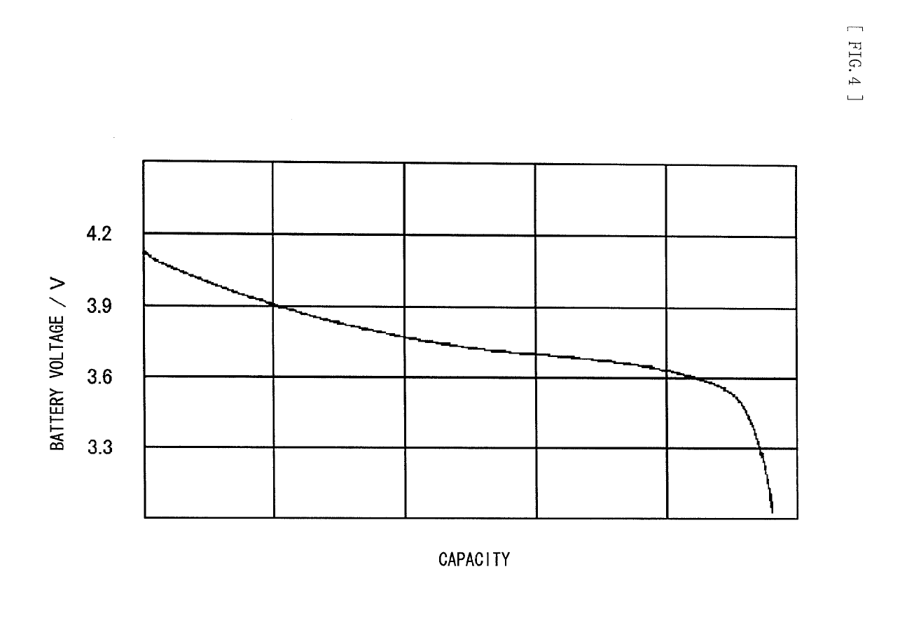

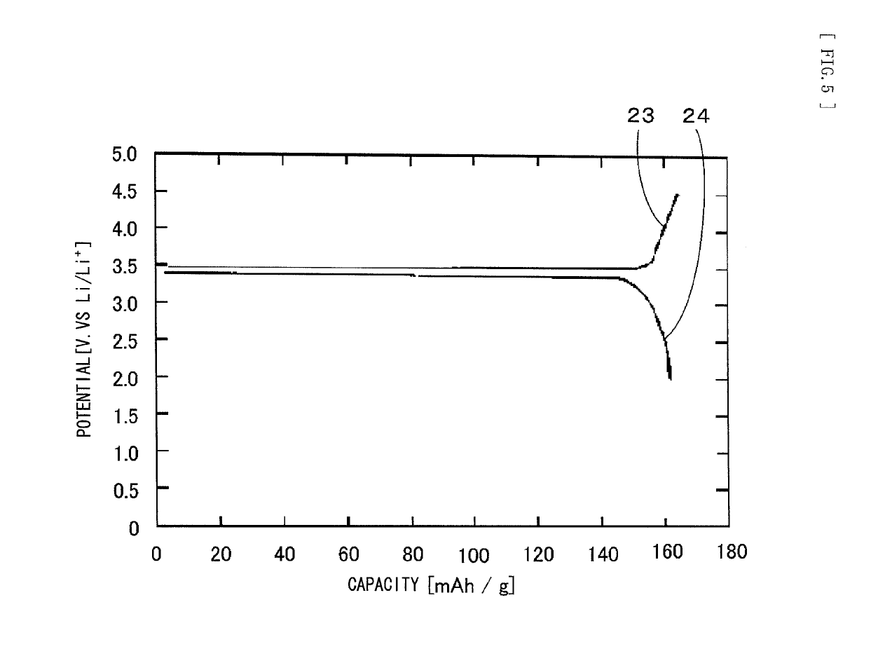

As a reference example, a discharge curve of a battery including a cathode made of Co(LiCoO₂) and an anode made of graphite is illustrated in FIG. 4. In this battery, in a discharge region where the SOC is as deep as 50% or over, the discharge curve is substantially flat, and it is difficult to detect the SOC from the battery voltage, so it is difficult to use the battery as the second battery. Moreover, potentials of an electrode made of LiFePO₄ in the case where an opposite electrode is made of Li metal are illustrated in FIG. 5. Reference numerals 23 and 24 indicate a charge potential and a discharge potential, respectively. In this case, the discharge curve is substantially flat, and it is difficult to detect the SOC from the battery voltage.

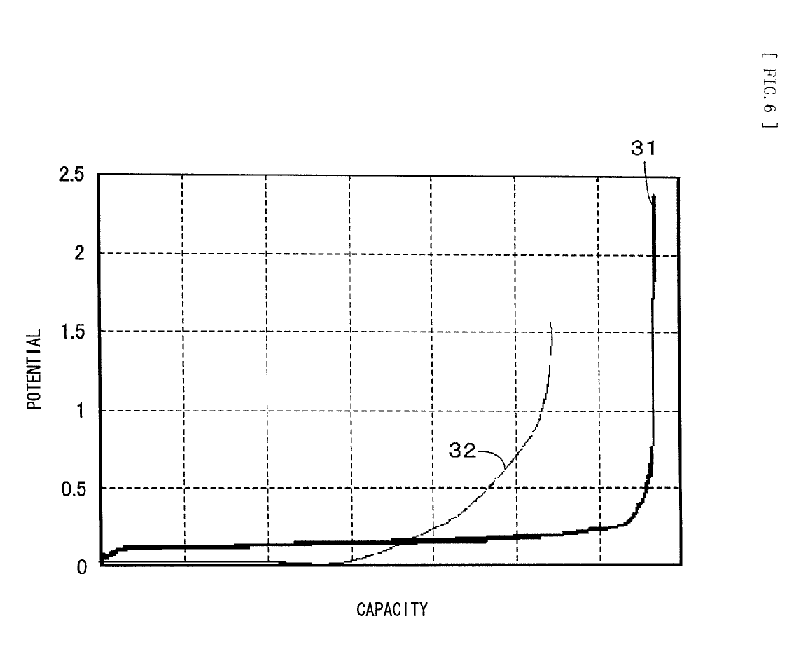

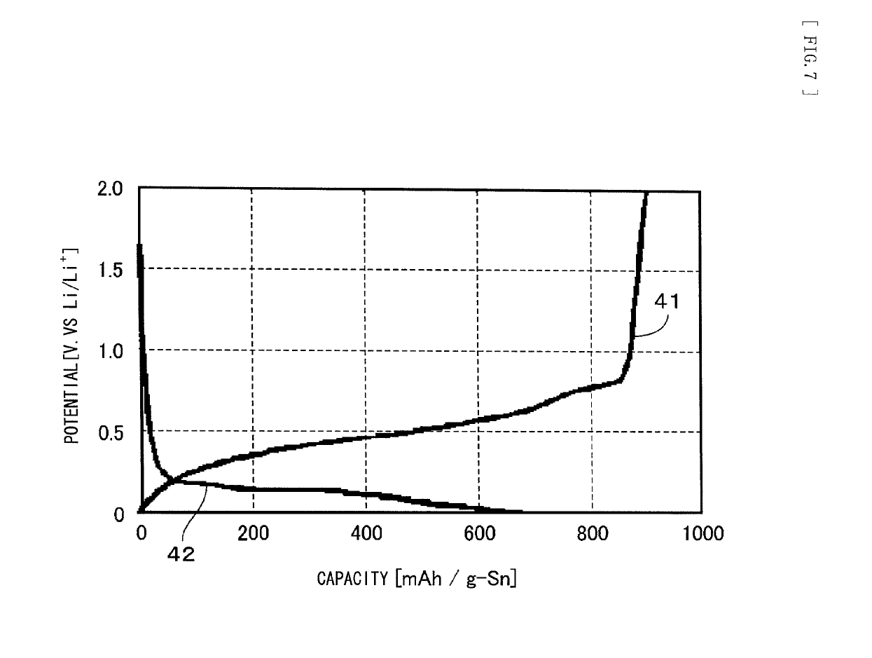

The anode material will be described below. As illustrated in FIG. 6, while a charge-discharge curve 31 of a battery using graphite as the anode material in the case where an opposite electrode is made of Li metal is flat, a charge-discharge curve 32 of a battery using hard carbon as the anode material in the case where an opposite electrode is made of Li metal exhibits slope characteristics, so the battery is used as the second battery. Further, as illustrated in FIG. 7, a discharge curve 41 of a battery using Sn metal as the anode material in the case where an opposite electrode is made of Li metal exhibits slope characteristics. A reference numeral 42 indicates a charge curve of the battery.

As described above, in the invention, an assembled battery is configured by connecting, in series, the first single battery having a discharge curve which exhibits substantially flat characteristics and the second signal battery having a discharge curve which exhibits slope characteristics. Therefore, while increasing the energy density of the assembled battery, the SOC (or the DOD) indicating the charge-discharge state of the assembled battery is allowed to be detected and computed easily with high accuracy.

### 2. Modification Examples

Although the embodiment of the present invention is described in detail, the invention is not limited thereto, and may be variously modified within the technical scope of the invention. For example, the discharge curve of a battery using a Si-based metal, a Si-based alloy or a mixture of such a metal and graphite for an anode exhibits slope characteristics, and the battery may be used as the second battery. Moreover, as lithium titanate exhibits flat characteristics, lithium titanate may be used for the first battery by combining lithium titanate with a cathode active material exhibiting flat characteristics. Although various active materials are exemplified, the invention is not limited thereto, and in the case where one of an anode active material and a cathode active material exhibits slope characteristics, a battery configured with use of these active materials exhibits slope characteristics and is allowed to be used as the second battery, and in the case where both of them exhibit flat characteristics, a battery configured with use of these active materials exhibits flat characteristics and is allowed to be used as the first battery. Further, two or more second single batteries may be connected in series to one another. Moreover, the assembled battery may have a configuration in which combinations of a plurality of batteries connected in series (or in parallel) are connected in parallel (or in series).

1. An assembled battery comprising:
one or a plurality of first single batteries and one or a plurality of second single batteries which are connected in series to one another, the first single batteries having a discharge curve which exhibits substantially flat characteristics, the second single batteries having a discharge curve which exhibits slope characteristics.

2. The assembled battery according to claim 1, wherein
the one or the plurality of first single batteries uses a graphite-based anode material, and the one or the plurality of second single batteries use a hard carbon-based anode material.

3. The assembled battery according to claim 1, wherein
the one or the plurality of first single batteries and the one or the plurality of second single batteries are configured so as to have substantially equal discharge capacity.

4. A method of controlling an assembled battery, the assembled battery including one or a plurality of first single batteries and one or a plurality of second single batteries which are connected in series to one another, the first single batteries having a discharge curve which exhibits substantially flat characteristics, the second single batteries having a discharge charge which exhibits slope characteristics, the method comprising a step of:
detecting an SOC or a DOD of the assembled battery from a terminal voltage of the second single battery.

5. The method of controlling an assembled battery according to claim 4, wherein
the one or the plurality of first single batteries use a graphite-based anode material, and the one or the plurality of second single batteries use a hard carbon-based anode material.

6. The method of controlling an assembled battery according to claim 4, wherein
the one or the plurality of first single batteries and the one or the plurality of second single batteries are configured so as to have substantially equal discharge capacity.

7. An electric vehicle comprising:
an assembled battery including one or a plurality of first single batteries and one or a plurality of second single batteries which are connected in series to one another, the first single batteries having a discharge curve which exhibits substantially flat characteristics, the second single batteries having a discharge curve which exhibits slope characteristics.

8. An energy storage system comprising:
a assembled battery including one or a plurality of first single batteries and one or a plurality of second single batteries which are connected in series to one another, the first single batteries having a discharge curve which exhibits substantially flat characteristics, the second single batteries having a discharge curve which exhibits slope characteristics.

9. A power tool comprising:
a assembled battery including one or a plurality of first single batteries and one or a plurality of second single batteries which are connected in series to one another, the first single batteries having a discharge curve which exhibits substantially flat characteristics, the second single batteries having a discharge curve which exhibits slope characteristics.
